(19) United States
(12) Patent Application Publication
(10) Pub. No.: US 2024/0367536 A1
(43) Pub. Date: Nov. 7, 2024

(54) VEHICULAR POWER GENERATOR FOR POWERING VEHICLE ACCESSORY RESPONSIVE TO AIR FLOW AS VEHICLE IS DRIVEN

(71) Applicant: Magna Electronics Inc., Auburn Hills, MI (US)

(72) Inventor: Sateesh Mutaguppe Kamalakar, Bangalore (IN)

(21) Appl. No.: 18/650,226

(22) Filed: Apr. 30, 2024

Related U.S. Application Data
(60) Provisional application No. 63/499,517, filed on May 2, 2023.

(51) Int. Cl. B60L 53/52; B60R 16/03; F03D 9/32

(52) U.S. Cl. CPC B60L 53/52; B60R 16/03; F03D 9/32; F05B 2220/706; F05B 2240/94

(57) ABSTRACT

A vehicular electrical power generation system includes an air capture device that is disposed at a vehicle and, when the vehicle is travelling in a forward direction, receives air flow through an inlet of the air capture device. A turbine is in fluid communication with the inlet and, responsive to air flow through the turbine, generates electricity. Electricity generated by the turbine is used to at least one of electrically charge a battery of the vehicle and electrically operate a system of the vehicle.

### CROSS REFERENCE TO RELATED APPLICATION

The present application claims the filing benefits of U.S. provisional application Ser. No. 63/499,517, filed May 2, 2023, which is hereby incorporated herein by reference in its entirety.

### FIELD OF THE INVENTION

The present invention relates generally to a vehicular power generator.

### BACKGROUND OF THE INVENTION

It is known to provide electrically powered vehicular accessories and components, including infotainment systems, headlights, windshield wipers, and windows. Typically, these electrically powered components are powered by a battery or by electric current generated by an alternator of the vehicle. The alternator also charges the battery while the vehicle is driven. In electric vehicles, the batteries that store energy for driving the vehicle are commonly recharged at stationary charging stations or regenerative braking techniques that generate power to charge the batteries when the brakes are applied while the vehicle is moving.

### SUMMARY OF THE INVENTION

A vehicular power generator or power generation system operates to capture air flow while a vehicle equipped with the power generation system moves in a forward direction to activate a turbine and charge a battery module with electricity generated from the activated turbine. The power generation system includes an air capture device with openings exposed at the exterior of the vehicle and air conduits or tunnels that guide captured air flow from the openings and along the conduits to the turbine. A plurality of conduits may guide air flow to a common concentrator tunnel or passage so that pressurized air is fed to the turbine. Energy from the turbine is then fed to a battery module to charge the battery module. The turbine may generate alternating current (AC) and, therefore, an inverter and direct current (DC) regulator circuit may be electrically coupled between the turbine and the battery module to convert the AC to regulated DC for charging the battery module.

For example, a vehicular power generation system includes a battery module configured to store energy. Energy stored by the battery module is used to electrically operate a system of a vehicle equipped with the vehicular power generation system. An air capture device is disposed at the vehicle. When the vehicle is travelling in a forward direction, the air capture device receives air flow through an inlet of the air capture device. The air capture device includes an outlet, and when the vehicle is travelling in the forward direction, the air capture device guides air flow from the inlet through the outlet, such as along a series of conduits that receive air flow through the opening of the air capture device. A turbine is configured to receive air flow from the outlet of the air capture device, and when the turbine receives air flow, the turbine generates electricity. The vehicular power generation system feeds electricity generated by the turbine to the battery module to electrically charge the battery module. Optionally, the vehicular power generation system may output electricity generated by the turbine for directly powering one or more systems of the vehicle, such as an electric drive system of the vehicle, a climate control system of the vehicle, a driving assistance system of the vehicle, and the like.

These and other objects, advantages, purposes and features of the present invention will become apparent upon review of the following specification in conjunction with the drawings.

### BRIEF DESCRIPTION OF THE DRAWINGS

FIG. 1 is a front view of a vehicle equipped with a vehicular power generation system;

FIG. 2 is a perspective view of an air capture device of the vehicular power generation system of FIG. 1;

FIG. 3 is a schematic view of the vehicular power generation system of FIG. 1;

FIG. 4 is a schematic view of a vehicular power generation system including turbines disposed at the openings of the air conduits;

FIG. 5 is a perspective view of an air capture device where the concentrator tunnel and turbine are offset relative to the array of air conduits;

FIG. 6 is a schematic view of a vehicular power generation system where first turbines are disposed at the openings of the air conduits and the air conduits feed air flow to second air conduits;

FIG. 7 is a perspective view of a vehicular power generation system where turbines are disposed along the hood of the vehicle; and

FIG. 8 is a schematic view of a vehicular power generation system where a plurality of air conduits feed air flow to a plurality of turbines.

### DESCRIPTION OF THE PREFERRED EMBODIMENTS

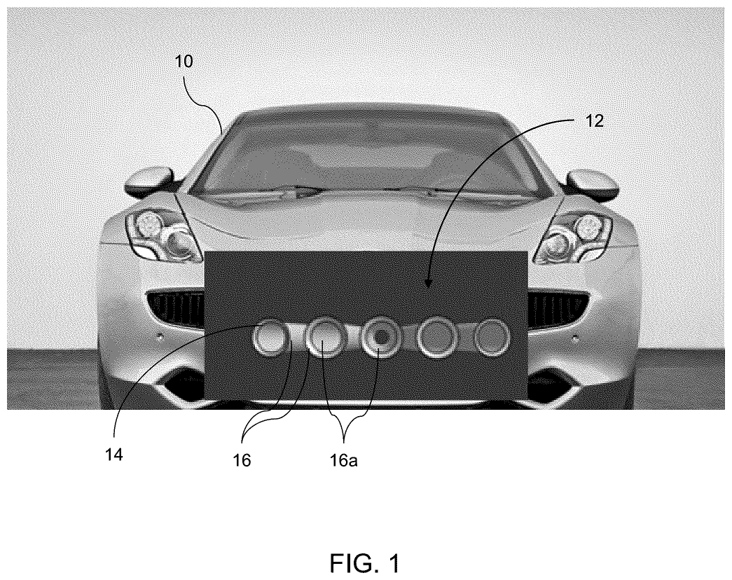

Referring now to the drawings and the illustrative embodiments depicted therein, a vehicle 10 includes a vehicular power generator or generation system 12 that generates electrical power when the vehicle 10 is moving (FIG. 1). The power generation system 12 uses air flow caused by the vehicle's movement to generate electricity and charge the vehicle's battery and/or electrically power electronic vehicular accessories. The vehicle 10 may have an electric drive system, where a battery of the vehicle 10 electrically powers a drive system of the vehicle, and the vehicle 10 may have electrically powered vehicular accessories that are electrically powered by the same battery powering the electric drive system or by an auxiliary battery dedicated to powering one or more vehicular accessories. Thus, the power generation system 12 may generate electricity to charge the battery or batteries that powers the electric drive system or an auxiliary battery that powers vehicular accessories, and/or the power generation system 12 may directly power the vehicular accessories.

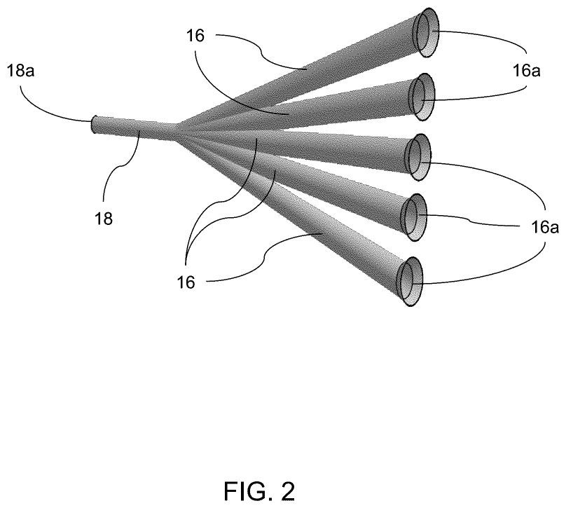

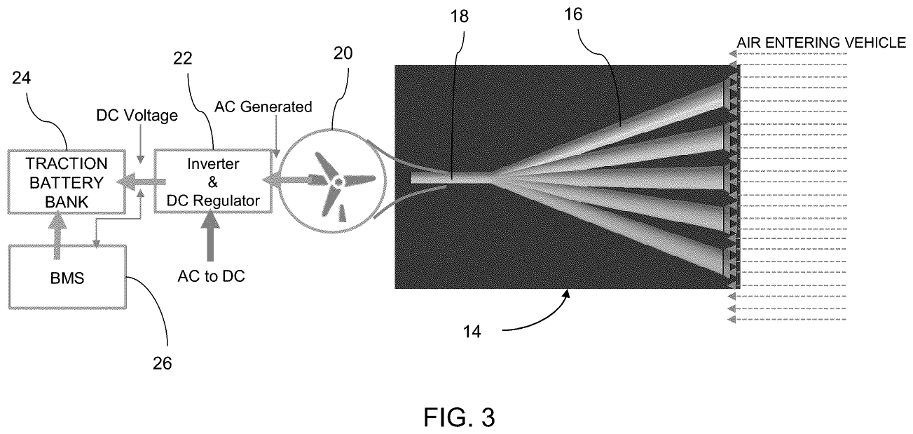

As shown in FIGS. 1-3, the vehicular power generation system 12 includes an air capture device 14 that captures the natural flow of air when the vehicle 10 is moving in a forward direction and feeds the air flow to a wind turbine 20. The air capture device 14 includes a plurality of air tunnels or pipes or channels or conduits 16 that each have a respective opening or air inlet 16a exposed exterior of the vehicle 10 and facing the forward direction of travel of the vehicle 10. That is, the air capture device 14 is fitted to the vehicle 10 such that the air entry point is open to the front side of the vehicle. For example, the openings 16a of the tunnels 16 are disposed at the front side of the vehicle, such as at or integrated with the front bumper or splitter or grill fascia of the vehicle. Optionally, the openings 16a may be disposed behind the grill fascia and open to receive air flow at the front of the vehicle 10, such as in front of the engine and/or radiator or in front of the engine or front trunk compartment.

The air conduits 16 each comprise a length of tube or passageway with the respective air inlets 16a facing forward of the vehicle 10 at a first end, and being commonly joined at second ends to an air concentrator tunnel or pipe or channel or conduit 18. That is, the second end of each air conduit 16, opposite the first opening end 16a, is fluidly connected to the concentrator tunnel 18. The concentrator tunnel 18 feeds the air flow from the air conduits 16 to the wind turbine 20 via an opening or air outlet 18a at an end of the concentrator tunnel 18 opposite the end connected to the air conduits 16. Put another way, the air capture device 14 feeds air flow to the wind turbine 20 via the air outlet 18a at a first end of the concentrator tunnel 18 and the second, opposite end of the concentrator tunnel 18 receives air flow from the plurality of conduits 16 that branch from or fluidly connect to the concentrator tunnel 18.

The air conduits 16 each taper from a larger diameter at the openings 16a to a smaller diameter at the concentrator tunnel 18 so that the concentrator tunnel 18 feeds pressurized air flow to the turbine 20. The concentrator tunnel 18 may comprise any suitable diameter to provide the air flow, such as a diameter that is less than or equal to the diameter of the air conduits 16 at the second ends that are coupled to the concentrator tunnel 18. The air capture device 14 may include any number of air conduits 16, such as at least two air conduits, at least four air conduits, at least five air conduits, at least six air conduits, at least eight conduits, and the like.

In the illustrated example of FIGS. 1-3, the air capture device 14 includes five air conduits 16 having openings 16a spaced horizontally from one another along the front of the vehicle 10 and with the conduits 16 extending between the concentrator tunnel 18 and the respective openings 16a in a fan-like pattern. Each of the air conduits 16 connects to the concentrator tunnel 18 at its respective second end opposite the opening 16a, and the concentrator tunnel 18 is disposed centrally relative to the array of conduits 16. The concentrator tunnel 18 feeds the concentrated air flow to the wind turbine 20, which may be directly connected to the air outlet 18a of the concentrator tunnel 18 or coupled to the concentrator tunnel 18 via an intermediate tunnel or adapter or the like.

When the air flow activates the turbine 20, the blades or rotor of the turbine 20 rotates and the turbine generates electricity to charge a battery module 24 of the vehicle and/or to electrically power vehicle accessories. Because the turbine 20 may generate alternating current (AC) electricity, the vehicular power generation system 12 may include an inverter and direct current (DC) regulator circuit or module 22 to convert the AC to DC and provide regulated DC to charge the battery module 24. Optionally, the inverter and DC regulator may be separate circuits or modules of the power generation system 12. Thus, when the vehicle 10 is moving and pressurized air flow is fed from the air capture device 14 to the turbine 20, the turbine 20 is activated and generates electricity. The AC generated by the turbine 20 is converted and regulated by the inverter and DC regulator circuit 22 to provide charging current to the battery module 24.

A battery management system (BMS) 26 of the vehicle 10 may control charging of the battery module 24 and may control discharge of the battery module 24, such as to operate the drive system of the vehicle 10 or to electrically power the vehicle accessories. For example, the BMS 26 may determine or detect the amount of DC (such as by detecting a voltage of the current flowing from the inverter and DC regulator circuit) being generated by the turbine 20 and determine or detect the level of charge of the battery module 24 to direct the charging current to the battery 24 or to power a system of the vehicle 10. Thus, the BMS 26 is in communication with the power generation system 12 and the battery module 24 to control or monitor or adjust the flow of electric current from the power generation system 12 to the battery module 24 and other vehicle systems.

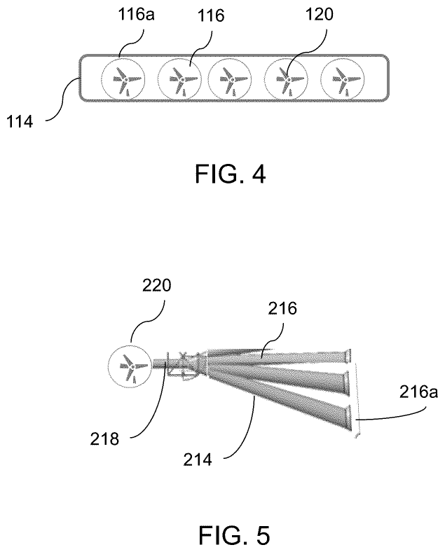

As shown in FIG. 4, an air capture device 114 includes an array of air conduits 116 having respective openings 116a disposed at the front of the vehicle where each air conduit 116 includes a turbine 120 disposed at or near the respective opening 116a of the air conduit 116. Thus, each air conduit 116 has its own respective turbine 120 and the plurality of turbines 120 collectively generate electricity to charge the battery module. In other words, the turbines 120 are directly mounted to the air conduits 116 at the front of the vehicle.

Referring to FIG. 5, an air capture device 214 includes an array of air conduits 216 where the concentrator tunnel 218 is offset from the center of the array of air conduits 216. In other words, the concentrator tunnel 218 is not centrally located relative to the openings 216a of the air capture device 214. The air capture device 214 may have any suitable configuration and the tunnel arrangement may have any suitable shape to drive the turbine 220. For example, the air capture device 214 may be configured to accommodate other structure of the vehicle, such as the exhaust system, suspension, and frame of the vehicle, to guide the air flow around such structure. Thus, the openings 216a of the air conduits 216 may be evenly spaced along the front side of the vehicle, with the air conduits 216 extending between the openings 216a and the concentrator tunnel 218 that extends along a side of the vehicle, such as along the driver side or passenger side of the vehicle. The air conduits 216 and/or concentrator tunnel 218 may include bends or curved portions to accommodate positions of structure underneath the vehicle (e.g., powertrain components, chassis and/or suspension components, body structure, and the like).

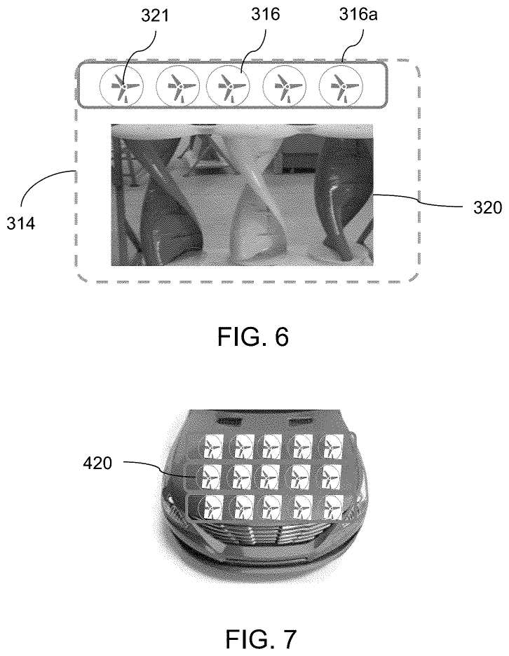

As shown in FIG. 6, an air capture device 314 includes air conduits 316 having respective openings 316a disposed along the front side of the vehicle, with first turbines 321 at or near the respective openings 316a of the air conduits 316 and one or more second turbines 320 disposed behind the openings 316a to maximize the energy capture of the device. For example, the second turbine 320 may be disposed at an air concentrator receiving airflow from the plurality of air conduits 316. Airflow passes through the openings 316a of the air conduits 316 and across the first turbines 321 and then across the one or more second turbines 320 so that both the first turbines 321 and the second turbines 320 generate electricity as the vehicle moves in a forward direction. Thus, the air capture device 314 includes turbines mounted at or near the front of the vehicle and one or more additional turbines mounted behind the other turbines to obtain maximum output.

With reference to FIG. 7, one or more turbines 420 may be disposed on or at the hood of the vehicle (or behind openings formed in the hood) to capture air flow across the hood, and without affecting the aerodynamics of the vehicle. That is, the turbines can be fitted on the vehicle bonnet without affecting aerodynamics.

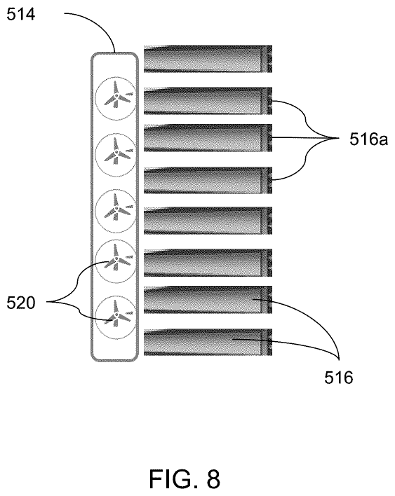

As shown in FIG. 8, an air capture device 514 may include a plurality of air conduits 516 where each conduit 516 feeds air flow from the respective opening 516a at the first end of the conduit 516 to a respective turbine 520 at the respective second ends of the air conduits 516. That is, the air conduits 516 are not commonly joined and instead each tunnel individually captures airflow to drive a respective turbine 520. Thus, the openings 516a to the air conduits 516 are exposed at the exterior of the vehicle and the individual conduits 516 extend rearward along the length of the vehicle toward respective turbines 520. Optionally, the array of conduits 516 may feed a plurality of turbines 520 where the number of turbines 520 is more or less than the number of air conduits 516. That is, the conduits 516 may collectively feed air to a grouping of turbines 520. For example, two or more air conduits 516 may direct airflow to an air concentrator tunnel housing one or more turbines while other air conduits 516 are not joined to any other air conduit and house their own respective turbines. In the illustrated example, eight conduits 516 feed air to five turbines 520.

Optionally, a screen or filter is disposed at the opening of the air capture device or along the air conduit or concentrator tunnel between the opening and the turbine to prevent objects, such as debris, bugs, and dirt, from entering the air capture device and restricting air flow or jamming the turbine. The air filter may include a fine screen or other material that catches foreign objects while minimally affecting air flow along the air capture device to the turbine. For example, the openings of the air capture device may be disposed behind a grille or mesh screen at the exterior portion of the vehicle.

Optionally, a flap or closure may be disposed at each opening or air inlet of the air capture device to selectively open and close the respective opening of the air conduit. For example, it may be desirable to close one or more conduits, such as to control the amount of air flow directed toward the turbine or prevent unwanted material from entering the air capture device. For example, if the vehicle is travelling in snowy conditions, each opening may be closed to prevent snow from clogging or damaging the air capture device. Further, the flaps may be opened and closed based on a drive mode of the vehicle, such as to open the flaps and generate energy with airflow across the turbines when the vehicle is operating in an eco-mode or energy generation mode, and to close the flaps and prevent airflow across the turbines when the vehicle is operating in a sport mode. Moreover, the flaps may be opened and closed based on a charge level of the battery, such as to open the flaps when the battery level has a low level of charge (e.g., open the flaps when the battery is below a first threshold level of charge like 25 percent or 50 percent) and to close the flaps when the battery has a high level of charge (e.g., close the flaps when the battery is above the first threshold level of charge or above a higher second threshold level of charge like 75 percent).

The openings may be disposed at any suitable position at the exterior of the vehicle. For example, the openings may be formed at or near or within the headlights, the hood, or the roof of the vehicle, such as along the roofline of the vehicle. Optionally, the openings may be disposed at a lower front portion of the vehicle, such as along a front bumper or grille or fascia of the vehicle. The air conduits extend rearward from the openings within the vehicle (i.e., behind the sheet metal, within the structure of the body of the vehicle) and include minimal twists or turns, so that air flow between the openings and turbine may be unrestricted to promote maximum energy generation.

Energy generated by the power generation system (and/or energy generated by the system and stored in the battery module) may be used to power the drive system of the vehicle or any suitable vehicular accessory. For example, energy may electrically power an infotainment system of the vehicle, a climate control system of the vehicle, power windows, electric power steering, headlights, and various sensors and sensor systems disposed at the vehicle (e.g., cameras, radars, lidars, and the like, such as for operating a driving assistance system of the vehicle).

Thus, electricity is generated from air entering the vehicle through the mill and generated electricity charges the traction battery in the electric vehicle. That is, the system generates electricity that can be used to charge the traction battery. In turn, this helps to increase the mileage available in one charge cycle.

Air enters through the tunnel pipe(s) fitted at the front of the vehicle and passes through the tunnels and gets concentrated and pressure develops near the turbine or wind mill. The turbine or wind mill generates the electricity. The turbine or wind mill generates AC that may be converted to DC. The AC may be regulated and combined with electric vehicle charging and battery management system (BMS) mechanisms.

Thus, the turbine or wind mill works/generates electricity when the vehicle is in motion with sufficient speed. Air enters through the tunnel pipe openings (e.g., six to eight or more openings) at the front side of the vehicle and may be concentrated at the concentrated air tunnel (i.e., a single pipe). The tunnel is designed such that the gradual diameter reduction and all six tunnel air enters to combine and create more pressure at the combining position along the pipe and that drives the wind turbine. The wind turbine generates the electricity. Then, AC is converted to DC. DC is regulated as per traction battery requirements and it controls the BMS also. This may include a standard inverter and AC-DC converter and BMS and traction battery available in electric vehicles. That is, the turbine may be used in an electric vehicle with traditional electric vehicle mechanisms.

The turbine is an integrated option and when the vehicle is moving, it generates electricity. The system may increase the overall mileage of electric vehicles and may help increase the vehicle's green foot print by providing natural resource utilization. No gasoline or fuel is required to operate the system. The system may be almost maintenance free. The system may be adapted for any size vehicle, such as small cars or big cars or trucks. The system may help significantly in saving electricity or fuel. The system helps solve electric vehicle mileage related problems based on configuration and design, such as understanding the aerodynamics of the vehicle, and combining the current charging path and the added generated electricity.

Optionally, the vehicular electrical power generation system may utilize characteristics of the power generation systems described in U.S. Publication No. US-2024-0116381, which is hereby incorporated herein by reference in its entirety.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular electrical power generation system, the vehicular electrical power generation system comprising:
an air capture device disposed at a vehicle equipped with the vehicular electrical power generation system, wherein, when the vehicle is travelling in a forward direction, the air capture device receives air flow through an inlet of the air capture device;
a turbine in fluid communication with the inlet of the air capture device, wherein, when the vehicle is travelling in the forward direction, and responsive to air flow through the turbine, the turbine generates electricity; and
wherein electricity generated by the turbine is used to at least one selected from the group consisting of (i) electrically charge a battery of the vehicle and (ii) electrically operate a system of the vehicle.

2. The vehicular electrical power generation system of claim 1, wherein the inlet of the air capture device comprises (i) a first opening of a first conduit of the air capture device and (ii) a second opening of a second conduit of the air capture device, and wherein, when the vehicle is travelling in the forward direction, the air capture device receives airflow through the first opening and the second opening.

3. The vehicular electrical power generation system of claim 2, wherein the air capture device comprises a concentrator tunnel that accommodates the turbine, and wherein the concentrator tunnel is in fluid communication with the first conduit and the second conduit, and wherein, when the vehicle is travelling in the forward direction, the airflow received through the first opening and the second opening is directed along the concentrator tunnel and through the turbine.

4. The vehicular electrical power generation system of claim 3, wherein a diameter of the concentrator tunnel is less than respective diameters of the first opening and the second opening so that the airflow received through the first opening and the second opening and directed along the concentrator tunnel and through the turbine is pressurized.

5. The vehicular electrical power generation system of claim 2, wherein the turbine comprises (i) a first turbine in fluid communication with the first opening and that generates electricity responsive to air flow received through the first opening and through the first turbine and (ii) a second turbine in fluid communication with the second opening and that generates electricity responsive to air flow received through the second opening and through the second turbine.

6. The vehicular electrical power generation system of claim 5, wherein the air capture device comprises a concentrator tunnel that accommodates a third turbine, and wherein the concentrator tunnel is in fluid communication with the first conduit and the second conduit, and wherein, when the vehicle is travelling in the forward direction, the airflow received through the first opening and the second opening is directed along the concentrator tunnel and through the third turbine.

7. The vehicular electrical power generation system of claim 1, wherein a flap is disposed at the inlet of the air capture device and operable between (i) a closed position where the flap is disposed over the inlet and precludes the air capture device from receiving airflow through the inlet and (ii) an opened position where the flap is moved from the closed position to permit the air capture device to receive airflow through the inlet.

8. The vehicular electrical power generation system of claim 7, wherein the vehicular electrical power generation system moves the flap between the closed position and the opened position based on at least one selected from the group consisting of (i) a drive mode of the vehicle, (ii) a current speed of the vehicle and (iii) a current charge level of the battery of the vehicle.

9. The vehicular electrical power generation system of claim 1, wherein the electricity generated by the turbine is used to electrically charge the battery of the vehicle.

10. The vehicular electrical power generation system of claim 9, wherein energy stored by the battery is used to electrically operate the system of the vehicle.

11. The vehicular electrical power generation system of claim 1, wherein the electricity generated by the turbine is used to electrically operate the system of the vehicle.

12. The vehicular electrical power generation system of claim 11, wherein the system of the vehicle comprises an electric drive system of the vehicle that, when electrically operated, is operable to move the vehicle in the forward direction.

13. The vehicular electrical power generation system of claim 11, wherein the system of the vehicle comprises one selected from the group consisting of (i) an infotainment system of the vehicle, (ii) a climate control system of the vehicle and (iii) a driving assistance system of the vehicle.

14. A vehicular electrical power generation system, the vehicular electrical power generation system comprising:
an air capture device disposed at a vehicle equipped with the vehicular electrical power generation system, wherein, when the vehicle is travelling in a forward direction, the air capture device receives air flow through an inlet of the air capture device;
a turbine in fluid communication with the inlet of the air capture device, wherein, when the vehicle is travelling in the forward direction, and responsive to air flow through the turbine, the turbine generates electricity;
wherein the air capture device comprises a concentrator tunnel that accommodates the turbine, and wherein a diameter of the concentrator tunnel is less than a diameter of the inlet so that airflow received through the inlet and directed along the concentrator tunnel and through the turbine is pressurized; and
wherein electricity generated by the turbine is used to electrically charge a battery of the vehicle.

15. The vehicular electrical power generation system of claim 14, wherein the inlet of the air capture device comprises (i) a first opening of a first conduit of the air capture device and (ii) a second opening of a second conduit of the air capture device, and wherein, when the vehicle is travelling in the forward direction, the air capture device receives airflow through the first opening and the second opening.

16. The vehicular electrical power generation system of claim 15, wherein the concentrator tunnel is in fluid communication with the first conduit and the second conduit, and wherein, when the vehicle is travelling in the forward direction, the airflow received through the first opening and the second opening is directed along the concentrator tunnel and through the turbine.

17. The vehicular electrical power generation system of claim 16, wherein the diameter of the concentrator tunnel is less than respective diameters of the first opening and the second opening.

18. The vehicular electrical power generation system of claim 14, wherein energy stored by the battery is used to electrically operate an electric drive system of the vehicle, and wherein the electric drive system of the vehicle, when electrically operated, is operable to move the vehicle in the forward direction.

19. A vehicular electrical power generation system, the vehicular electrical power generation system comprising:
an air capture device disposed at a vehicle equipped with the vehicular electrical power generation system, wherein, when the vehicle is travelling in a forward direction, the air capture device receives air flow through an inlet of the air capture device;
wherein the inlet of the air capture device comprises (i) a first opening of a first conduit of the air capture device and (ii) a second opening of a second conduit of the air capture device, and wherein, when the vehicle is travelling in the forward direction, the air capture device receives airflow through the first opening and the second opening;
a first turbine in fluid communication with the inlet of the air capture device, wherein, when the vehicle is travelling in the forward direction, and responsive to air flow received through the first opening and through the first turbine, the first turbine generates electricity;
a second turbine in fluid communication with the inlet of the air capture device, wherein, when the vehicle is travelling in the forward direction, and responsive to air flow received through the second opening and through the second turbine, the second turbine generates electricity; and
wherein electricity generated by the first turbine and the second turbine is used to electrically charge a battery of the vehicle.

20. The vehicular electrical power generation system of claim 19, wherein the air capture device comprises a concentrator tunnel that accommodates a third turbine, and wherein the concentrator tunnel is in fluid communication with the first conduit and the second conduit, and wherein, when the vehicle is travelling in the forward direction, the airflow received through the first opening and the second opening is directed along the concentrator tunnel and through the third turbine.

21. The vehicular electrical power generation system of claim 19, wherein a flap is disposed at the inlet of the air capture device and operable between (i) a closed position where the flap is disposed over the inlet and precludes the air capture device from receiving airflow through the inlet and (ii) an opened position where the flap is moved from the closed position to permit the air capture device to receive airflow through the inlet.

22. The vehicular electrical power generation system of claim 19, wherein the battery electrically powers an electric drive system of the vehicle, and wherein the electric drive system of the vehicle, when electrically powered, is operable to move the vehicle in the forward direction.
